(19) United States
(12) Patent Application Publication
(10) Pub. No.: US 2019/0020192 A1
(43) Pub. Date: Jan. 17, 2019

(54) POWER SUPPLY MANAGEMENT CIRCUIT AND POWER SUPPLY MANAGEMENT METHOD

(71) Applicant: INSPUR ELECTRONIC INFORMATION INDUSTRY CO., LTD, Jinan, Shandong (CN)

(72) Inventor: Jimiao CAI, Jinan, Shandong (CN)

(73) Assignee: INSPUR ELECTRONIC INFORMATION INDUSTRY CO., LTD, Jinan, Shandong (CN)

(21) Appl. No.: 15/745,135

(22) PCT Filed: Dec. 13, 2016
(86) PCT No.: PCT/CN2016/109578

§ 371 Date: Jan. 15, 2018

(30) Foreign Application Priority Data
Aug. 31, 2016 (CN) 201610777604.6

(51) Int. Cl. H02H 7/10; H02M 1/36; H02H 3/08; H02H 9/04

(52) U.S. Cl. CPC H02H 7/10; H02H 9/04; H02H 3/08; H02M 1/36

(57) ABSTRACT

A power supply management circuit and method are provided. The circuit includes: a power-supplying copper bar configured to receive a power-supplying voltage from an external power supply; at least two power-supplying terminals configured to output the power-supplying voltage of the power-supplying copper bar to a hot plugging unit; the hot plugging unit connected to the at least two power-supplying terminals and a pin interface and configured to receive the power-supplying voltage outputted from the power-supplying terminals, detect whether node overcurrent occurs currently, disconnect from the at least two power-supplying terminals if node overcurrent occurs currently, and output the power-supplying voltage via a first interface in the pin interface if no overcurrent occurs currently; and a PCIE strip configured to output a signal via a second interface in the pin interface.

### FIELD

The present disclosure relates to the technical field of an electronic circuit, and in particular to a power supply management circuit and a power supply management method.

### BACKGROUND

In a whole cabinet server, power is supplied in a centralized manner. In the whole cabinet server, components such as a power supply and a node are connected to a power-supplying copper bar. The power supply outputs a voltage to the power-supplying copper bar, and components such as the node take power from the power-supplying copper bar.

Power is supplied in a centralized manner in the whole cabinet server and the copper bar is configured to supply power for all node servers, therefore it is more important to manage the power supply connected to the power-supplying copper bar. For example, since a voltage of the copper bar is high, it is important to take power from the power-supplying copper bar more safely, so as to avoid node damage and so on due to overcurrent.

### SUMMARY

According to embodiments of the present disclosure, a power supply management circuit and a power supply management method are provided, such that a power supply can be managed more effectively.

A power supply management circuit is provided, which includes a power-supplying copper bar, at least two power-supplying terminals, a hot plugging unit, a pin interface and a PCIE strip, where the power-supplying copper bar is connected to an external power supply and is configured to receive a power-supplying voltage from the external power supply;

the at least two power-supplying terminals are connected to the power-supplying copper bar and are configured to output a power-supplying voltage of the power-supplying copper bar to the hot plugging unit;

the hot plugging unit is connected to the at least two power-supplying terminals and the pin interface, and is configured to receive the power-supplying voltage outputted from the power-supplying terminals, detect whether node overcurrent occurs currently, disconnect from the at least two power-supplying terminals in a case that the node overcurrent occurs currently, and output the power-supplying voltage via a first interface in the pin interface in a case that the node overcurrent does not occur currently; and

the PCIE strip is configured to output a signal via a second interface in the pin interface.

The pin interface is a 24PIN pin interface; and/or the PCIE strip is a PCIE×4 connecting finger.

The power supply management circuit further includes a voltage conversion unit connected to the first interface in the pin interface and configured to receive the power-supplying voltage from the first interface, divide the power-supplying voltage into a power supply voltage and a hard disk voltage, output the hard disk voltage to a hard disk, and output the divided power supply voltage to an external node.

A node management unit MM is further provided between the pin interface and the voltage conversion unit, where

the MM is configured to monitor power consumption of a node, perform functions of OCP and OVP, and output the power-supplying voltage outputted from the first interface in the pin interface to the voltage conversion unit.

The power supply management circuit further includes a PCIE×16 connecting finger and a voltage switching unit, where

the MM is configured to transmit the signal outputted from the second interface in the pin interface to the PCIE×16 connecting finger, and output the power-supplying voltage outputted from the first interface in the pin interface to the PCIE×16 connecting finger;

the PCIE×16 connecting finger is connected to the MM and an external mainboard and is configured to output the received signal to the external mainboard, output the received power-supplying voltage to the external mainboard, and output a startup control signal transmitted from the external mainboard to the voltage switching unit; and

the voltage switching unit is connected between the MM and the voltage conversion unit, and is configured to output the power-supplying voltage outputted from the MM to the voltage conversion unit in a case that the startup control signal is not received and supply power for the mainboard and the hard disk synchronously in a case that the startup control signal is received.

The power supply voltage is 12V and the hard disk voltage is 5V.

A power supply management method based on any of the power supply management circuits described above is provided, which includes:

outputting, by the power-supplying copper bar, the power-supplying voltage received from the external power supply to the at least two power-supplying terminals;

outputting, by the at least two power-supplying terminals, the power-supplying voltage to the hot plugging unit;

detecting, by the hot plugging unit, whether node overcurrent occurs currently, disconnecting, by the hot plugging unit, from the at least two power-supplying terminals in a case that the node overcurrent occurs currently, and outputting, by the hot plugging unit, the power-supplying voltage via the first interface in the pin interface in a case that the node overcurrent does not occur currently; and

outputting, by the PCIE strip, a signal via the second interface in the pin interface.

The pin interface is a 24PIN pin interface; and/or the PCIE strip is a PCIE×4 connecting finger.

After the outputting the power-supplying voltage via the first interface in the pin interface, the method further includes:

receiving, by an MM, the power-supplying voltage outputted via the first interface in the pin interface;

outputting, by the MM, the power-supplying voltage to a voltage conversion unit; and

dividing, by the voltage conversion unit, the received power-supplying voltage into a power supply voltage and a hard disk voltage; outputting, by the voltage conversion unit, the hard disk voltage to a hard disk; and outputting, by the voltage conversion unit, the divided power supply voltage to an external node.

The power supply voltage is 12V and the hard disk voltage is 5V.

According to the embodiments of the present disclosure, a power supply management circuit and a power supply management method are provided. For a feature that power is supplied in a centralized manner by the power-supplying copper bar in a whole cabinet server, the at least two power-supplying terminals, the hot plugging unit, the pin interface and the PCIE strip are provided accordingly. The at least two power-supplying terminals are connected to the power-supplying copper bar and are configured to output a power-supplying voltage of the power-supplying copper bar to the hot plugging unit; the hot plugging unit is connected to the at least two power-supplying terminals and the pin interface, and is configured to receive the power-supplying voltage outputted from the power-supplying terminals, detect whether node overcurrent occurs currently, disconnect from the at least two power-supplying terminals in a case that the node overcurrent occurs currently, and output the power-supplying voltage via a first interface in the pin interface in a case that the node overcurrent does not occur currently; and the PCIE strip is configured to output a signal via a second interface in the pin interface. By accordingly providing the circuit and cooperation of components in the circuit, such as adding the power-supplying terminals, adding the hot plugging unit and detecting overcurrent by the hot plugging unit, a function for protecting the power supply can be achieved.

### BRIEF DESCRIPTION OF THE DRAWINGS

In order to illustrate technical solutions in embodiments of the present disclosure or the conventional technology more clearly, drawings for the description of the embodiments or the conventional technology are introduced simply hereinafter. Apparently, the drawings described in the following only describe some embodiments of the present disclosure. For those skilled in the art, other drawings may be obtained according to the drawings without any creative work.

FIG. 1 is a schematic structural diagram of a power supply management circuit according to an embodiment of the present disclosure;

FIG. 2 is a schematic structural diagram of a power supply management circuit according to another embodiment of the present disclosure;

FIG. 3 is a schematic structural diagram of a power supply management circuit according to another embodiment of the present disclosure;

FIG. 4 is a schematic structural diagram of a power supply management circuit according to another embodiment of the present disclosure;

FIG. 5 is a schematic structural diagram of a power supply management circuit according to another embodiment of the present disclosure; and

FIG. 6 is a flowchart of managing a power supply according to an embodiment of the present disclosure.

### DETAILED DESCRIPTION

In order to make objects, technical solutions and advantages of embodiments of the present disclosure become more clearly, the technical solutions in the embodiments of the present disclosure are described clearly and completely in conjunction with drawings in the embodiments of the present disclosure hereinafter. Apparently, the described embodiments are some rather than all of the embodiments of the present disclosure. Any other embodiments obtained based on the embodiments of the present disclosure by those skilled in the art without any creative work fall within the protection scope of the present disclosure.

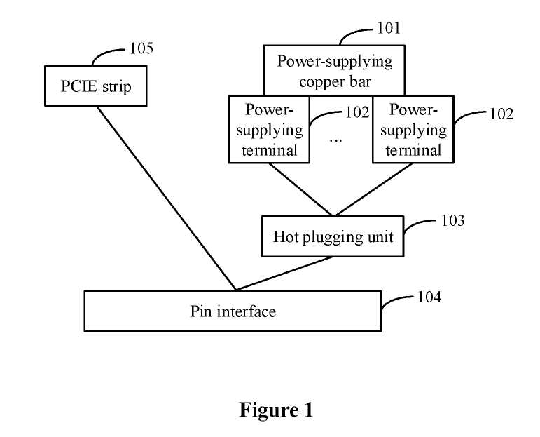

As shown in FIG. 1, a power supply management circuit is provided according to an embodiment of the present disclosure, which includes: a power-supplying copper bar 101, at least two power-supplying terminals 102, a hot plugging unit 103, a pin interface 104 and a PCIE strip 105. The power-supplying copper bar 101 is connected to an external power supply and is configured to receive a power-supplying voltage from the external power supply. The at least two power-supplying terminals 102 are connected to the power-supplying copper bar 101 and are configured to output a power-supplying voltage of the power-supplying copper bar 101 to the hot plugging unit 103. The hot plugging unit 103 is connected to the at least two power-supplying terminals 102 and the pin interface 104, and is configured to receive the power-supplying voltage outputted from the power-supplying terminals 102, detect whether node overcurrent occurs currently, disconnect from the at least two power-supplying terminals 102 in a case that the node overcurrent occurs currently, and output the power-supplying voltage via a first interface in the pin interface 104 in a case that the node overcurrent does not occur currently. And the PCIE strip 105 is configured to output a signal via a second interface in the pin interface 104.

It follows that, in the power supply management circuit according to the embodiment of the present disclosure shown in FIG. 1, for a feature that power is supplied in a centralized manner by the power-supplying copper bar in a whole cabinet server, the at least two power-supplying terminals, the hot plugging unit, the pin interface and the PCIE strip are provided accordingly. The at least two power-supplying terminals are connected to the power-supplying copper bar and are configured to output a power-supplying voltage of the power-supplying copper bar to the hot plugging unit; the hot plugging unit is connected to the at least two power-supplying terminals and the pin interface, and is configured to receive the power-supplying voltage outputted from the power-supplying terminals, detect whether node overcurrent occurs currently, disconnect from the at least two power-supplying terminals in a case that the node overcurrent occurs currently, and output the power-supplying voltage via a first interface in the pin interface in a case that the node overcurrent does not occur currently; and the PCIE strip is configured to output a signal via a second interface in the pin interface. By accordingly providing the circuit and cooperation of components in the circuit, such as adding the power-supplying terminals, adding the hot plugging unit and detecting overcurrent by the hot plugging unit, a function for protecting the power supply can be achieved.

In addition, in the power supply management circuit according to the embodiment of the present disclosure shown in FIG. 1, not only a wiring link for the power-supplying voltage is designed, but also a wiring link for a signal is designed. The wiring link for the power-supplying voltage connects the power-supplying copper bar 101, the at least two power-supplying terminals 102, the hot plugging unit 103 and the pin interface 104. The wiring link for the signal connects the PCIE strip 105 and the pin interface 104. That is, the power supply management circuit according to the embodiment of the present disclosure shown in FIG. 1 can not only provide the power-supplying voltage and corresponding power-supplying protection for the node in the whole cabinet server, but also provide a signal communication link. Such a structure of the power supply management circuit is simple and practical.

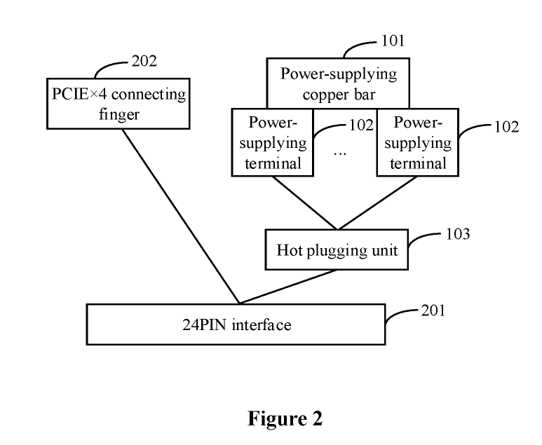

As shown in FIG. 2, in an embodiment of the present disclosure, the pin interface in the power supply management circuit is a 24PIN pin interface 201, and the PCIE strip 105 is a PCIE×4 connecting finger 202.

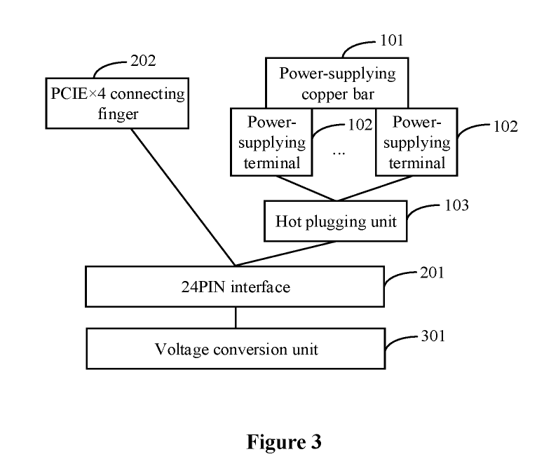

In an embodiment of the present disclosure, in order to further enhance the function for power management, voltage conversion is to be performed, such that a power supply voltage outputted from the power-supplying copper bar, such as 12V, can meet power-supplying requirements of different components, particularly a power-supplying requirement of a hard disk. For this case, as shown in FIG. 3, the power supply management circuit may further include a voltage conversion unit 301.

The voltage conversion unit 301 is connected to the first interface in the 24PIN interface 201, receives the power-supplying voltage from the first interface, divides the power-supplying voltage into a power supply voltage such as 12V and a hard disk voltage such as 5V, outputs the hard disk voltage such as 5V to an external hard disk, and outputs the divided power supply voltage such as 12V to an external node.

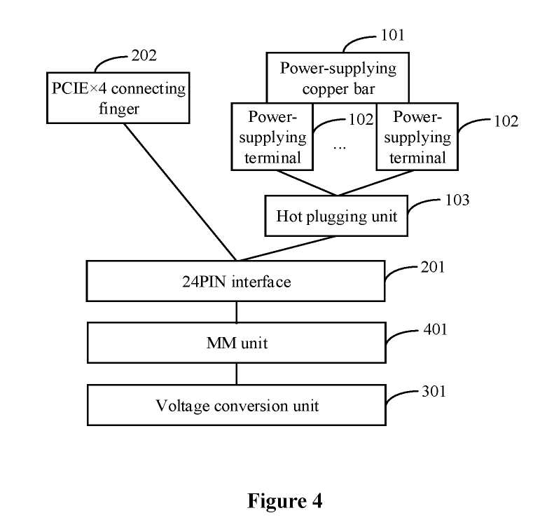

As shown in FIG. 4, in an embodiment of the present disclosure, in order to further enhance an effect for managing the power supply, a node management MM unit 401 is further provided between the pin interface 104 and the voltage conversion unit 301.

The MM unit 401 is configured to monitor power consumption of a node and perform functions of OCP and OVP, and output the power-supplying voltage outputted from the first interface in the 24PIN interface 201 to the voltage conversion unit 301.

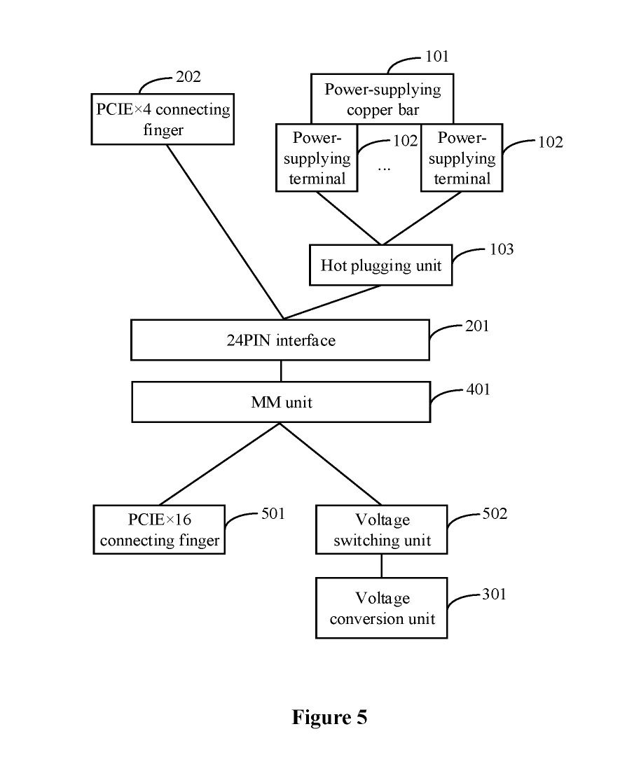

As shown in FIG. 5, in an embodiment of the present disclosure, in order to further enhance an effect for managing the power supply, the power supply management circuit further includes: a PCIE×16 connecting finger 501 and a voltage switching unit 502.

The MM unit 401 is configured to transmit the signal outputted from the second interface in the 24PIN interface 201 to the PCIE×16 connecting finger 501, and output the power-supplying voltage outputted from the first interface in the 24PIN interface 201 to the PCIE×16 connecting finger 501.

The PCIE×16 connecting finger 501 is connected to the MM unit 401 and an external mainboard, and is configured to output the received signal to the external mainboard, output the received power-supplying voltage to the external mainboard, and output a startup control signal transmitted from the external mainboard to the voltage switching unit 502.

The voltage switching unit 502 is connected between the MM unit 401 and the voltage conversion unit 301. The voltage switching unit 502 outputs the power-supplying voltage outputted from the MM unit 401 to the voltage conversion unit 301 in a case that the startup control signal is not received; and supplies power for the mainboard and the hard disk synchronously in a case that the startup control signal is received.

In the embodiment of the present disclosure, the power supply voltage may be 12V and the hard disk voltage may be 5V.

With reference to the power supply management circuit according to the embodiment of the present disclosure shown in FIG. 5, by means of structures and cooperation of the power-supplying copper bar, the at least two power-supplying terminals, the hot plugging unit and the 24PIN interface, the power supply can be protected. Further, by means of structures and cooperation of the voltage conversion unit, the MM unit, the PCIE×16 connecting finger and the voltage switching unit, voltage conversion can be implemented. Therefore, the power supply management circuit can protect a node power supply in the whole cabinet server and implement voltage conversion, thereby greatly enhancing practicability in actual services.

As shown in FIG. 5, in an embodiment of the present disclosure, functions of components of the power supply management circuit are illustrated by examples as follows.

1. A protection circuit (i.e., the hot plugging unit 103), which can achieve hot plugging of a node and can achieve OCP of automatically interrupts power-taking from the copper bar when overcurrent occurs in a node.

2. A power-taking port (i.e., the at least two power-supplying terminals 102), which is directly socketed on the power-supplying copper bar 101 to take power +12V for the node.

3. A node signal connecting finger (i.e., the PCIE×4 connecting finger 202), which can gather management signals for nodes into a node middle board.

4. A mainboard power-supplying and signal interface, which is implemented as the pin interface 104, for example one 24PIN interface 201.

The components 1 to 4 described above are configured to achieve a function of power-supplying protection and may form a power-supplying protection board.

5. The pin interface 104, such as a 24PIN interface, which is connected to the power-supplying protection board through a cable, and couples a power-supplying signal and a management signal.

6. The NM unit 401, which monitors power consumption of a node and performs functions of OCP and OVP.

7. The voltage conversion unit 301, which achieves +12V/+5V and provides the power-supplying voltage of +5V for a node hard disk.

8. The voltage switching unit 502, which switches between +12V and +5V, supplies power for the mainboard and the hard disk synchronously when the node startups, and achieves a switching function by a PSON signal from the mainboard.

9. The PCIE×16 connecting finger 501, which achieves interconnection with the mainboard by socketing on the PCIE×16 interface of the mainboard.

The components 5 to 9 described above are configured to achieve a function of voltage conversion and may form a power-supplying adapter board.

It should be noted that, in the power supply management circuits according to the embodiments of the present disclosure shown in FIG. 2 to FIG. 5, it is illustrated by assuming that the pin interface 104 is a 24PIN interface 201 and the PCIE strip is a PCIE×4 connecting finger 202. In other embodiments of the present disclosure, the 24PIN interface 201 in FIG. 2 may be replaced with other forms of pin interfaces. Practically, in other embodiments of the present disclosure, the PCIE×4 connecting finger 202 in FIG. 2 may be replaced with other forms of PCIE strips.

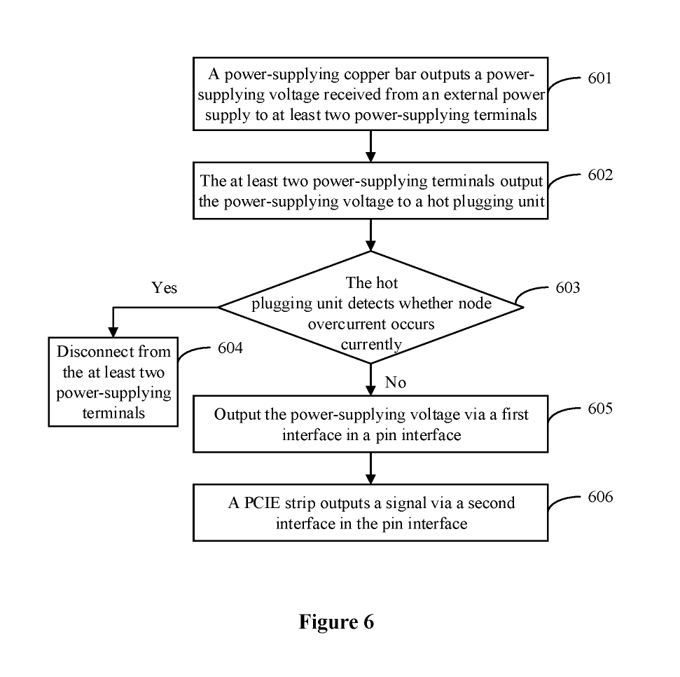

According to an embodiment of the present disclosure, a power supply management method based on any of the power supply management circuits according to the present disclosure is further provided. As shown in FIG. 6, the method includes steps 601 to 606 in the following.

In step 601, a power-supplying copper bar outputs a power-supplying voltage received from an external power supply to at least two power-supplying terminals.

In step 602, the at least two power-supplying terminals output the power-supplying voltage to a hot plugging unit.

In step 603, the hot plugging unit detects whether node overcurrent occurs currently; step 604 is performed in a case that the node overcurrent occurs currently; and step 605 is performed in a case that the node overcurrent does not occur currently.

In step 604, it is disconnected from the at least two power-supplying terminals, and a current flow ends.

In step 605, the power-supplying voltage is outputted via a first interface in the pin interface.

In the step, the pin interface may be a 24PIN pin interface.

In step 606, a PCIE strip outputs a signal via a second interface in the pin interface.

In the step, the PCIE strip may be a PCIE×4 connecting finger.

By means of the process shown in FIG. 6, a node power supply can be protected.

After the power-supplying voltage is outputted via the first interface in the pin interface in step 605, a process of voltage conversion for the node power supply may be further performed. The process may include:

receiving, by an MM, the power-supplying voltage outputted via the first interface in the pin interface;

outputting, by the MM, the power-supplying voltage to a voltage conversion unit; and

dividing, by the voltage conversion unit, the received power-supplying voltage into a power supply voltage and a hard disk voltage; outputting, by the voltage conversion unit, the hard disk voltage to a hard disk; and outputting, by the voltage conversion unit, the divided power supply voltage to an external node.

In the process shown in FIG. 6, the power supply voltage is 12V, and the hard disk voltage is 5V.

The embodiments of the present disclosure have at least the following beneficial effects.

1. In the embodiments of the present disclosure, for a feature that power is supplied in a centralized manner by the power-supplying copper bar in a whole cabinet server, the at least two power-supplying terminals, the hot plugging unit, the pin interface and the PCIE strip are provided accordingly. The at least two power-supplying terminals are connected to the power-supplying copper bar and are configured to output a power-supplying voltage of the power-supplying copper bar to the hot plugging unit; the hot plugging unit is connected to the at least two power-supplying terminals and the pin interface, and is configured to receive the power-supplying voltage outputted from the power-supplying terminals, detect whether node overcurrent occurs currently, disconnect from the at least two power-supplying terminals in a case that the node overcurrent occurs currently, and output the power-supplying voltage via a first interface in the pin interface in a case that the node overcurrent does not occur currently; and the PCIE strip is configured to output a signal via a second interface in the pin interface. By accordingly providing the circuit and cooperation of components in the circuit, such as adding the power-supplying terminals, adding the hot plugging unit and detecting overcurrent by the hot plugging unit, a function for protecting the power supply can be achieved.

2. In the embodiments of the present disclosure, not only a wiring link for the power-supplying voltage is designed, but also a wiring link for a signal is designed. That is, the power supply management circuit according to the embodiment of the present disclosure can not only provide the power-supplying voltage and corresponding power-supplying protection for the node in the whole cabinet server, but also provide a signal communication link. Such a structure of the power supply management circuit is simple and practical.

3. In the embodiments of the present disclosure, by means of structures and cooperation of the voltage conversion unit, the MM unit, the PCIE×16 connecting finger and the voltage switching unit in the power supply management circuit, voltage conversion can be implemented. Therefore, such power supply management circuit can implement voltage conversion for a node power supply in the whole cabinet server, and meet the power-supplying requirement of the hard disk for example, thereby greatly enhancing practicability in actual services.

It should be noted that the relationship terminologies such as “first”, “second” and the like are only used herein to distinguish one entity or operation from another, rather than to necessitate or imply that the actual relationship or order exists between the entities or operations. Furthermore, terms of “include”, “comprise” or any other variants are intended to be non-exclusive. Therefore, a process, method, article or device including multiple elements includes not only the elements but also other elements that are not enumerated, but also the elements inherent for the process, method, article or device. Unless expressively limited otherwise, the statement “comprising (including) one . . . ” does not exclude the case that other similar elements may exist in the process, method, article or device.

It should be understood by those skilled in the art that, all or a part of steps for achieving the method embodiments above may be performed by hardware related to program instructions, and the programs may be stored in a computer readable storage medium. When the programs are executed, steps in the method embodiments are performed. The storage medium includes various mediums which may store program codes, such as an ROM, an RAM, a magnetic disk or an optical disk.

Finally, it should be noted that, the contents described above are only preferred embodiments of the present disclosure, are only used to illustrate technical solutions of the present disclosure and are not intended to limit the protection scope of the present disclosure. Any changes, equivalent substitutions and improvements and so on made based on the spirit and principles of the present disclosure fall within the protection scope of the present disclosure.

1. A power supply management circuit, comprising:
a power-supplying copper bar, at least two power-supplying terminals, a hot plugging unit, a pin interface and a PCIE strip, wherein
the power-supplying copper bar is connected to an external power supply and is configured to receive a power-supplying voltage from the external power supply;
the at least two power-supplying terminals are connected to the power-supplying copper bar and are configured to output a power-supplying voltage of the power-supplying copper bar to the hot plugging unit;
the hot plugging unit is connected to the at least two power-supplying terminals and the pin interface, and is configured to receive the power-supplying voltage outputted from the power-supplying terminals, detect whether node overcurrent occurs currently, disconnect from the at least two power-supplying terminals in a case that the node overcurrent occurs currently, and output the power-supplying voltage via a first interface in the pin interface in a case that the node overcurrent does not occur currently; and
the PCIE strip is configured to output a signal via a second interface in the pin interface.

2. The power supply management circuit according to claim 1, wherein the pin interface is a 24PIN pin interface;
and/or
the PCIE strip is a PCIE×4 connecting finger.

3. The power supply management circuit according to claim 1, further comprising:
a voltage conversion unit connected to the first interface in the pin interface and configured to receive the power-supplying voltage from the first interface, divide the power-supplying voltage into a power supply voltage and a hard disk voltage, output the hard disk voltage to a hard disk, and output the divided power supply voltage to an external node.

4. The power supply management circuit according to claim 3, further comprising a node management unit MM provided between the pin interface and the voltage conversion unit, wherein
the MM is configured to monitor power consumption of a node, perform functions of OCP and OVP, and output the power-supplying voltage outputted from the first interface in the pin interface to the voltage conversion unit.

5. The power supply management circuit according to claim 4, further comprising a PCIE×16 connecting finger and a voltage switching unit, wherein
the MM is configured to transmit the signal outputted from the second interface in the pin interface to the PCIE×16 connecting finger, and output the power-supplying voltage outputted from the first interface in the pin interface to the PCIE×16 connecting finger;
the PCIE×16 connecting finger is connected to the MM and an external mainboard and is configured to output the received signal to the external mainboard, output the received power-supplying voltage to the external mainboard, and output a startup control signal transmitted from the external mainboard to the voltage switching unit; and
the voltage switching unit is connected between the MM and the voltage conversion unit, and is configured to output the power-supplying voltage outputted from the MM to the voltage conversion unit in a case that the startup control signal is not received and supply power for the mainboard and the hard disk synchronously in a case that the startup control signal is received.

6. The power supply management circuit according to claim 3, wherein the power supply voltage is 12V and the hard disk voltage is 5V.

7. A power supply management method, comprising:
outputting, by a power-supplying copper bar, a power-supplying voltage received from an external power supply to at least two power-supplying terminals;
outputting, by the at least two power-supplying terminals, the power-supplying voltage to a hot plugging unit;
detecting, by the hot plugging unit, whether node overcurrent occurs currently, disconnecting, by the hot plugging unit, from the at least two power-supplying terminals in a case that the node overcurrent occurs currently, and outputting, by the hot plugging unit, the power-supplying voltage via a first interface in a pin interface in a case that the node overcurrent does not occur currently; and
outputting, by the PCIE strip, a signal via a second interface in the pin interface.

8. The method according to claim 7, wherein the pin interface is a 24PIN pin interface;
and/or
the PCIE strip is a PCIE×4 connecting finger.

9. The method according to claim 8, wherein after the outputting the power-supplying voltage via the first interface in the pin interface, the method further comprises:
receiving, by an MM, the power-supplying voltage outputted via the first interface in the pin interface;
outputting, by the MM, the power-supplying voltage to a voltage conversion unit; and
dividing, by the voltage conversion unit, the received power-supplying voltage into a power supply voltage and a hard disk voltage; outputting, by the voltage conversion unit, the hard disk voltage to a hard disk; and outputting, by the voltage conversion unit, the divided power supply voltage to an external node.

10. The method according to claim 9, wherein the power supply voltage is 12V and the hard disk voltage is 5V.

11. The power supply management circuit according to claim 4, wherein the power supply voltage is 12V and the hard disk voltage is 5V.

12. The power supply management circuit according to claim 5, wherein the power supply voltage is 12V and the hard disk voltage is 5V.
